(19) United States
(12) Patent Application Publication
(10) Pub. No.: US 2023/0001982 A1
(43) Pub. Date: Jan. 5, 2023

(54) STEERING DEVICE DETECTING THE AIRTIGHTNESS OF ROAD WHEEL ACTUATOR

(71) Applicant: MANDO CORPORATION, Pyeongtaek (KR)

(72) Inventors: Myungseob SON, Seoul (KR); Hyunsik HAN, Suwon (KR)

(21) Appl. No.: 17/750,318

(22) Filed: May 21, 2022

(30) Foreign Application Priority Data
Jul. 2, 2021 (KR) 10-2021-0087006

(51) Int. Cl. B62D 5/04; G01L 19/00

(52) U.S. Cl. CPC B62D 5/0496; B62D 5/0406; G01L 19/0092; G07C 5/0825

(57) ABSTRACT

A steering device detecting airtightness of a road wheel actuator is proposed. The road wheel actuator includes a body unit, a motor unit connected to the body unit, and a controller connected to the motor unit. The controller checks an airtight state of a housing and bellows surrounding the body unit, the motor unit, and the controller.

### TECHNICAL FIELD

The present disclosure relates to a steering device and, more particularly, to a steering device detecting the airtightness of a road wheel actuator, which detects the airtightness of the road wheel actuator by measuring and comparing the pressure data and temperature data of the road wheel actuator.

### BACKGROUND

Power steering has been developed and applied to a steering device of a vehicle to assist a driver's force in operating a steering wheel and thereby provide convenience in driving.

The power steering is classified into hydraulic power steering using hydraulic pressure, electro-hydraulic power steering using both hydraulic pressure and the electric power of a motor, and electric type power steering using only the electric power of a motor.

Recently, a mechanical coupling device such as a steering column, a universal joint, or a pinion shaft between a steering wheel and a wheel is removed, and a Steer By Wire (SBW) type steering device which steers a vehicle using a motor has been developed and applied.

The SBW type steering device is problematic in that it has no mechanical coupling between a steering shaft and a wheel, so that the feeling of weight due to the friction of the wheel and obstacles on a road surface is not transmitted to a driver and thereby a steering feel is deteriorated. Accordingly, the conventional SBW related invention mainly focuses on improving the steering feel of a driver.

However, the SBW type steering device is driven by a road wheel actuator (RWA), and is problematic in that the airtightness of the road wheel actuator is not maintained uniformly depending on driving environment, so that a component of the road wheel actuator may become rusty, and the performance of the road wheel actuator may be deteriorated.

### CITED DOCUMENT

### Patent Document

Japanese Patent Laid-Open Publication No. 2018-95059 (Jun. 21, 2018)

### SUMMARY

In view of the above, the present disclosure provides a steering device detecting the airtightness of a road wheel actuator, in which a pressure sensor and a temperature sensor are mounted on the road wheel actuator, thus detecting the airtightness of the road wheel actuator by measuring a change in pressure or a change in pressure depending on a change in temperature.

The objects to be solved by the present disclosure are not limited to the above-mentioned objects, and may be variously expanded without departing from the spirit and scope of the present disclosure.

In order to accomplish the object, exemplary embodiments of the present disclosure provide a steering device detecting the airtightness of a road wheel actuator, in which a controller measures temperature data and/or pressure data of the road wheel actuator, and compares the measured temperature data or pressure data with reference pressure data or reference temperature-pressure data, thus checking the airtight state of the road wheel actuator.

A steering device detecting the airtightness of a road wheel actuator according to an embodiment of the present disclosure can detect the airtightness of the road wheel actuator. The road wheel actuator includes a body unit, a motor unit connected to the body unit, and a controller connected to the motor unit. The controller checks an airtight state of a housing and bellows surrounding the body unit, the motor unit, and the controller.

According to an embodiment, a pressure sensor is attached to the controller. The pressure sensor measures internal pressure of the housing and the bellows surrounding the body unit, the motor unit, and the controller.

According to an embodiment, the controller includes reference pressure data. The controller receives pressure data from the pressure sensor, compares the received pressure data with the reference pressure data, and determines that there is an abnormality in the airtightness of the road wheel actuator when the received pressure data is lower than the reference pressure data. The reference pressure data is pressure data measured by the pressure sensor when the airtightness of the road wheel actuator is in a normal state.

According to an embodiment, the steering device further includes a display unit. The display unit is electrically connected to the controller to display an airtight state of the road wheel actuator. The controller transmits an electrical signal to the display unit when it is determined that there is an abnormality in the airtightness of the road wheel actuator.

According to an embodiment, the display unit displays the abnormality in the airtightness of the road wheel actuator, when the display unit receives the electrical signal from the controller.

According to an embodiment, a temperature sensor is attached to the controller. The temperature sensor measures internal temperature of the housing and the bellows surrounding the body unit, the motor unit, and the controller.

According to an embodiment, the controller includes reference temperature-pressure data. The controller receives temperature data and pressure data from the temperature sensor and the pressure sensor, respectively, calculates pressure data corresponding to the temperature data, compares the pressure data corresponding to the temperature data with the reference temperature-pressure data, and determines that there is an abnormality in the airtightness of the road wheel actuator when the pressure data corresponding to the temperature data is lower than the reference temperature-pressure data. The reference temperature-pressure data is the pressure data corresponding to the temperature data, measured by the temperature sensor and the pressure sensor when the airtightness of the road wheel actuator is in a normal state.

### Advantageous Effects

A steering device detecting the airtightness of a road wheel actuator according to an embodiment of the present disclosure can detect whether there is an abnormality in the road wheel actuator, that is, the airtight state of the road wheel actuator is maintained.

Further, it is possible to detect whether rust forms in the road wheel actuator.

Furthermore, it is possible to detect whether there is an abnormality in the road wheel actuator before it is impossible to steer a vehicle due to the abnormality of the road wheel actuator, thereby minimizing human and material damage caused by steering inability.

However, the effects of the present disclosure are not limited to the above effects, and may be variously expanded without departing from the spirit and scope of the present disclosure.

### BRIEF DESCRIPTION OF THE DRAWINGS

FIG. 1 is a diagram illustrating the configuration of a steering device detecting the airtightness of a road wheel actuator according to an embodiment of the present disclosure.

FIG. 2 is a diagram illustrating the road wheel actuator of FIG. 1.

FIG. 3 is a diagram schematically illustrating the configuration of a body unit of FIG. 2.

FIG. 4 is a diagram schematically illustrating the configuration of a controller of FIG. 2.

FIG. 5 is a flowchart illustrating an operation in which the controller measures pressure data to detect the airtightness of the road wheel actuator.

FIG. 6 is a diagram illustrating the gradient of pressure depending on temperature.

### DETAILED DESCRIPTION

Hereinafter, embodiments of the present disclosure will be described in detail with reference to the accompanying drawings. When it is determined that some components of the present disclosure are clearly understood and easily reproduced by those skilled in the art, detailed description thereof will be omitted so as not to obscure the gist of the present disclosure.

Hereinafter, a steering device detecting the airtightness of a road wheel actuator according to an embodiment of the present disclosure will be described.

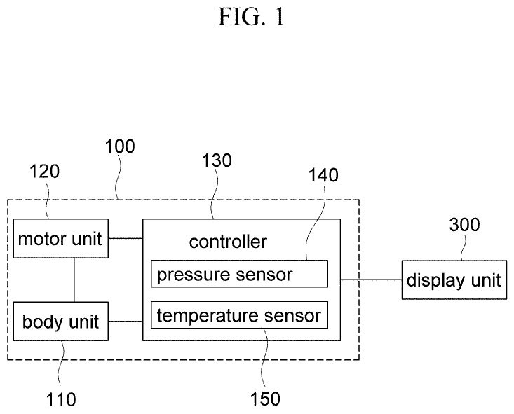

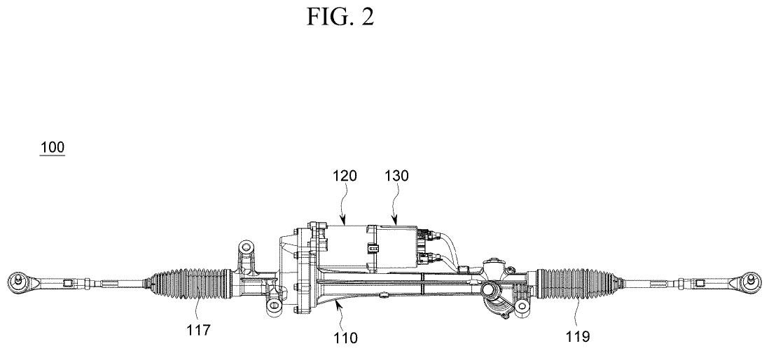

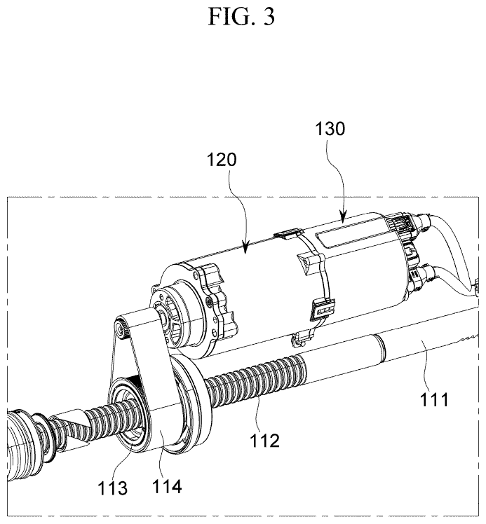

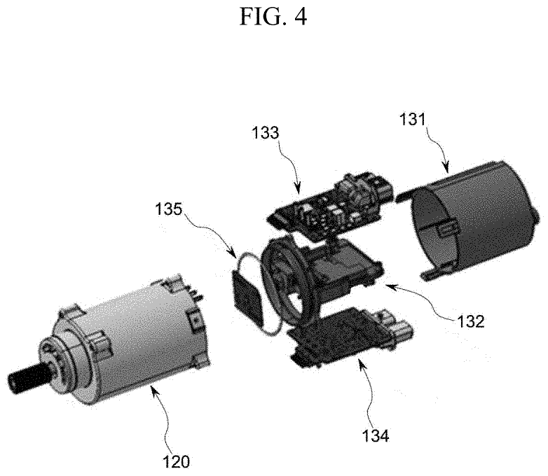

FIG. 1 is a diagram illustrating the configuration of a steering device detecting the airtightness of a road wheel actuator according to an embodiment of the present disclosure, FIG. 2 is a diagram illustrating the road wheel actuator of FIG. 1, FIG. 3 is a diagram schematically illustrating the configuration of a body unit of FIG. 2, and FIG. 4 is a diagram schematically illustrating the configuration of a controller of FIG. 2.

Referring to FIGS. 1 to 4, the steering device detecting the airtightness of the road wheel actuator according to an embodiment of the present disclosure includes a road wheel actuator (RWA) 100 and a display unit 300 which displays the airtight state of the road wheel actuator 100.

The road wheel actuator 100 according to an embodiment of the present disclosure includes a body unit 110, a motor unit 120 connected to the body unit 110, and a controller 130 connected to the motor unit 120. The controller 130 checks the airtight state of a housing and bellows 117 and 119 surrounding the body unit 110, the motor unit 120, and the controller 130.

Further, the road wheel actuator 100 includes the housing and the bellows 117 and 119 surrounding the body unit 110.

The body unit 110 may be kept airtight by the housing and the bellows 117 and 119 surrounding the body unit 110. Herein and hereinafter, the expression “the airtight state is maintained” means that there is no abnormality (including problem, defect, or the like) in the airtight state.

The bellows 117 and 119 surround both ends of a rack bar 111, respectively. One end and the other end of the bellows 17 and 19 may be fixed with a clip and a steel band.

The bellows 117 and 119 may be made of rubber material, and be easily damaged by foreign substance splashed from a road during the repeated steering and the driving of the vehicle.

When the bellows 117 and 119 are damaged, contaminants and moisture may flow into the bellows 117 and 119 and the housing, so that rust may form therein, and the weight of a handle may be increased due to the rust.

Therefore, in order to uniformly maintain the airtightness of the road wheel actuator 100, it is necessary to uniformly maintain the airtight state of the road wheel actuator 100.

If the bellows 117 and 119 are damaged, the pressure in the bellows 117 and 119 and the housing is changed (e.g. decreased) compared to a normal state where the bellows 117 and 119 are not damaged, so that it is possible to determine whether the bellows 117 and 119 are damaged or not by measuring the pressure in the bellows 117 and 119 and the housing.

The body unit 110 includes the rack bar 111 disposed in the housing surrounding the body unit 110, and the rack bar 111 may include a screw groove 112 and a rack gear (not shown) which is formed to be spaced apart from the screw groove by a predetermined distance.

Both ends of the rack bar 111 are disposed in the bellows 117 and 119.

The screw groove 112 may be formed on the outer circumference of the rack bar 111 to have a predetermined length, and be connected to a rotating shaft of the motor unit 120 by a belt 114.

The rack gear may be spaced apart from the screw groove 112 by a predetermined distance, and be formed on a side of the outer circumference of the rack bar 111 to have a predetermined length. The rack gear may be connected to a pinion gear (not shown) which is formed on a pinion shaft (not shown).

The body unit 110 may be electrically connected to the controller 130.

Further, the body unit 110 may include a ball-nut 113 and a belt 114 disposed in the housing surrounding the body unit 110.

The ball-nut 113 may engage with the screw groove 112 formed on the rack bar 111 via a ball.

The motor unit 120 may be spaced apart from the rack bar 111 by a predetermined distance, and be disposed on the housing of the body unit 110 surrounding the rack bar 111.

The belt 114 may connect the motor unit 120 and the ball-nut 113. To be more specific, the belt 114 may be disposed on a pulley disposed on the rotating shaft of the motor unit 120 and a nut pulley coupled to the outer circumference of the ball-nut 113 to connect the pulley and the nut pulley and thereby connect the motor unit 120 and the ball-nut 113.

If the rotating shaft of the motor unit 120 is rotated in one direction or an opposite direction, the ball-nut 113 is rotated through the belt 114, and the ball disposed in the ball-nut 113 moves in the screw groove 112 formed on the rack bar 111. Thus, the rack bar 111 may move leftwards or rightwards.

Further, the body unit 110 may include a pinion shaft (not shown) and a support member (not shown) which may support the rack bar 111 moving leftwards or rightwards. The pinion shaft and the support member may support the rack bar 111 so that the rack bar 111 is not tilted when the rack boar 111 is moved by driving the motor unit 120.

The pinion shaft may have the pinion gear meshing with the rack gear formed on the rack bar 111.

The above-described driving of the motor unit 120 and belt 114, rotation of the ball-nut 113, movement of the rack bar 111, driving of various components constituting the body unit 110, and driving of various components constituting the controller 130 increase the internal temperature of the body unit 110, the motor unit 120, and the controller 130.

The interior of the housing and the bellows 117 and 119 surrounding the body unit 110 and the interior of the motor unit 120 and the controller 130 are kept airtight.

It can be seen that a change in volume of the interior of the housing and the bellows 117 and 119 surrounding the body unit 110 and the interior of the motor unit 120 and the controller 130 is very small. Therefore, the pressure of the interior of the housing and the bellows 117 and 119 surrounding the body unit 110 and the interior of the motor unit 120 and the controller 130 increases as temperature rises.

Furthermore, according to an embodiment of the present disclosure, if the bellows 117 and 119 are damaged, the internal pressure of the housing, the bellows 117 and 119, the motor unit 120, and the controller 130 may be equal or similar to the atmospheric pressure without being significantly affected by the rise of temperature.

The body unit 110 is kept airtight. In order to maintain the airtight state of the body unit 110, the housing surrounding the body unit 110 is formed to surround the belt 114 connected to the motor unit 120, portions other than both ends of the rack bar 111, the ball-nut 113, the pinion shaft, etc. Both ends of the rack bar 111 are surrounded by the bellows 117 and 119.

Each of the motor unit 120 and the controller 130 includes a cover. The cover of the motor unit 120 is formed to define the appearance of the motor unit 120 and keep the interior of the motor unit 120 airtight. The cover 131 of the controller 130 is formed to define the appearance of the controller 130 and keep the interior of the controller 130 airtight.

If the housing and the bellows 117 and 119 surrounding the body unit 110, the cover of the motor unit 120, and the cover 131 of the controller 130 are cracked or damaged, or problems occur in components which may maintain the airtightness, so that the airtight state of the housing, the bellows 117 and 119, the motor unit 120, and the controller 130 is not maintained, water or moisture may penetrate into the housing, the bellows 117 and 119, the motor unit 120, and the controller 130 while the vehicle is running or stopped, and water or moisture may cause rust in the components of the body unit 110, the motor unit 120, and the controller 130. Herein and hereinafter, the expression “the airtight state is not maintained” means that there is an abnormality in the airtight state.

Since the rust forming in the housing and the bellows 117 and 119 surrounding the body unit 110, the motor unit 120, and the controller 130 may deteriorate the performance of the road wheel actuator 100, it is necessary to continuously check whether the airtight state of the housing and the bellows 117 and 119 surrounding the body unit 110, the motor unit 120, and the controller 130 is maintained.

If the motor unit 120 of the road wheel actuator 100 is driven, so that various components constituting the road wheel actuator 100 are operated, the internal pressure of the housing and the bellows 117 and 119 surrounding the body unit 110, the motor unit 120, and the controller 130 is increased because the internal temperature of the housing and the bellows 117 and 119 surrounding the body unit 110, the motor unit 120, and the controller 130 rises, and the internal volume of the housing and the bellows 117 and 119 surrounding the body unit 110, the motor unit 120, and the controller 130 is constant.

If the housing and the bellows 117 and 119 surrounding the body unit 110, the cover of the motor unit 120, and the cover 131 of the controller 130 are cracked or damaged, or problems occur in components which may maintain the airtightness, so that the airtight state of the housing, the bellows 117 and 119, the motor unit 120, and the controller 130 is not maintained, an increase in the internal pressure of the housing and the bellows 117 and 119 surrounding the body unit 110, the motor unit 120, and the controller 130 is reduced compared to a case where the airtight state of the housing, the bellows 117 and 119, the motor unit 120, and the controller 130 is maintained.

Alternatively, according to an embodiment of the present disclosure, if the bellows 117 and 119 are damaged, the internal pressure of the housing, the bellows 117 and 119, the motor unit 120, and the controller 130 may be equal or similar to the atmospheric pressure without being significantly affected by the rise of temperature.

Thus, the pressure sensor 140 and the temperature sensor 150 are attached to the controller 130 to measure the pressure data and the temperature data in the housing and the bellows 117 and 119 surrounding the body unit 110, the motor unit 120, and the controller 130, and then compare the measured pressure data and temperature data with reference pressure data and/or temperature data input (stored) when the airtight state of the housing and the bellows 117 and 119 surrounding the body unit 110, the motor unit 120, and the controller 130 is maintained, thus determining whether there is an abnormality in the airtight state of the housing, the bellows 117 and 119, the motor unit 120, and the controller 130.

Further, when the airtight state of the housing and the bellows 117 and 119 surrounding the body unit 110, the motor unit 120, and the controller 130 is not maintained, it is displayed on a display window to inform a user that the airtight state of the road wheel actuator 100 is not maintained.

The steering device detecting the airtightness of the road wheel actuator 100 according to an embodiment of the present disclosure includes the pressure sensor 140 and the temperature sensor 150.

The pressure sensor 140 may be attached to the controller 130, and may measure the internal pressure of the housing and the bellows 117 and 119 surrounding the body unit 110, the motor unit 120, and the controller 130.

The pressure sensor 140 may transmit the measured pressure (pressure data) to the controller 130. That is, the controller 130 may receive the pressure data from the pressure sensor 140.

The temperature sensor 150 may be attached to the controller 130, and may measure the internal temperature of the housing and the bellows 117 and 119 surrounding the body unit 110, the motor unit 120, and the controller 130.

The temperature sensor 150 may transmit the measured temperature (temperature data) to the controller 130. That is, the controller 130 may receive the temperature data from the temperature sensor 150.

The motor unit 120 is a driving motor which is generally used in the road wheel actuator 100.

The motor unit 120 is electrically connected to the controller 130, is controlled by the controller 130, and is driven in response to an electrical signal of the controller 130.

The controller 130 may be electrically connected to the steering wheel of the vehicle, and be also electrically connected to the motor unit 120 to control the motor unit 120.

The controller 130 may be disposed on a side of the motor unit 120 to be physically and electrically connected thereto. The controller 130 and the motor unit 120 may be connected (or fastened) through various fastening methods, for example, a bolt fastening method, a screw fastening method, a rotary fastening method, or a hook fastening method.

The controller 130 may include an input device, a storage device, an information processing device, and an output device.

The input device, the storage device, the information processing device, and the output device may be disposed on at least one of a first control unit 133, a second control unit 134, or a third control unit 135 disposed in the cover 131 of the controller 130. The first control unit 133, the second control unit 134, and the third control unit 135 may be a kind of printed circuit board (PCB), and may include various electronic components. The printed circuit board and the various electronic components are factors which increase the internal temperature of the controller 130.

Further, the controller 130 may include in the cover 131 a heat sink 132 which may emit heat transmitted as the motor unit 120 is driven or heat generated from various printed circuit boards of the controller 130. The heat sink 132 may prevent temperature in the various printed circuit boards of the controller 130 from being increased.

The input device may receive the temperature data transmitted from the temperature sensor 150, the pressure data transmitted from the pressure sensor 140, the reference temperature-pressure data, and the reference pressure data, and the storage device may store the above-described pieces of data.

The information processing device may compare and analyze the above-described pieces of data using inputted and stored software. Specifically, according to embodiments of the present disclosure, the controller 130 may measure the pressure data of the body unit 110 and then compare the measured pressure data with the inputted reference pressure data. When a difference in pressure between the pressure data and the reference pressure data is more than a predetermined value, the controller 130 may display the abnormality of the road wheel actuator 100 on the display unit 300 which will be described below, using the output device. Herein and hereinafter, the expression “the abnormality of the road wheel actuator 100” means that the airtightness of the road wheel actuator 100 is deteriorated, and indicates that the airtight state of the body unit 110 of the road wheel actuator 100 is not maintained.

The controller 130 may be electrically connected to the body unit 110 and the motor unit 120, and may control the driving of the motor unit 120.

The pressure sensor 140 and the temperature sensor 150 may be attached to the controller 130.

The controller 130 may check the airtight state of the housing and the bellows 117 and 119 surrounding the body unit 110, the motor unit 120, and the controller 130 using the pressure sensor 140 and the temperature sensor 150.

The controller 130 may drive the motor unit 120, may measure the pressure data and the temperature data in the housing and the bellows 117 and 119 surrounding the body unit 110, the motor unit 120, and the controller 130 from the pressure sensor 140 and the temperature sensor 150, and may receive the measured pressure data and temperature data.

The controller 130 may be electrically connected to the display unit 300 which will be described below, and may transmit an electrical signal to the display unit 300 when the airtight state of the housing and the bellows 117 and 119 surrounding the body unit 110, the motor unit 120, and the controller 130 is abnormal.

According to an embodiment of the present disclosure, the controller 130 may include reference pressure data. The reference pressure data indicates pressure data measured by the pressure sensor 140 when the airtightness of the road wheel actuator 100 is in a normal state. The expression “the airtightness of the road wheel actuator 100 is in the normal state” means that the housing and the bellows 117 and 119 surrounding the body unit 110, the cover of the motor unit 120, and the cover 131 of the controller 130 are not cracked or damaged, or no problem occurs in components which may maintain the airtightness, so that the airtight state of the housing, the bellows 117 and 119, the motor unit 120, and the controller 130 is maintained.

The controller 130 may measure the internal pressure of the housing and the bellows 117 and 119 surrounding the body unit 110, the motor unit 120, and the controller 130 using the pressure sensor 140.

The controller 130 may receive pressure data from the pressure sensor 140, and may compare the received pressure data with pre-inputted reference pressure data. Further, when the received pressure data is lower than the reference pressure data, the controller 130 may determine that there is an abnormality in the airtightness of the road wheel actuator 100.

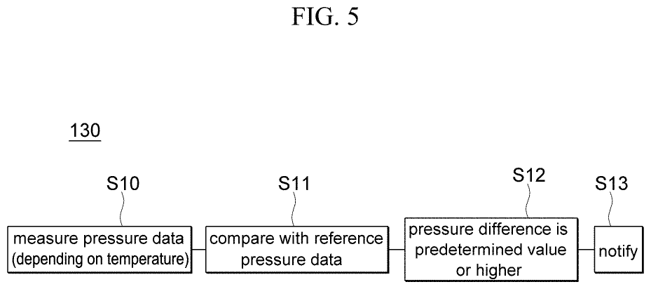

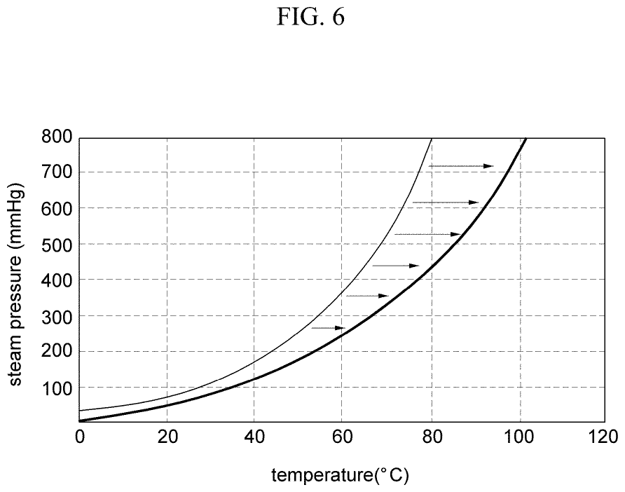

FIG. 5 is a flowchart illustrating an operation in which the controller 130 measures pressure data to detect the airtightness of the road wheel actuator 100, and FIG. 6 is a diagram illustrating the gradient of pressure (pressure data) depending on temperature (temperature data). Hereinafter, the present disclosure will be described with reference to FIGS. 1 to 6.

When the controller 130 compares the received pressure data with the stored reference pressure data and a difference in pressure between the received pressure data and the reference pressure data is more than a predetermined value, the controller 130 may determine that there is an abnormality in the airtight state of the housing and the bellows 117 and 119 surrounding the body unit 110, the motor unit 120, and the controller 130, and then may transmit an electrical signal to the display unit 300.

The controller 130 may measure the internal temperature of the housing and the bellows 117 and 119 surrounding the body unit 110, the motor unit 120, and the controller 130 using the temperature sensor 150.

The controller 130 may measure the pressure data depending on the temperature (S10), and may compare the inputted data and the stored reference pressure data (S11). When the pressure data is more than the reference pressure data by a predetermined value (S12) (i.e. when a difference between the pressure data and the reference pressure data is more than a predetermined value), the controller 130 may display the abnormality (specifically, a reduction in the airtightness of the road wheel actuator 100) of the road wheel actuator 100 (S13). Here, the predetermined value may be optionally determined by a user. In this regard, the pressure data depending on the temperature indicates the pressure data corresponding to the temperature data, and the reference pressure data indicates the reference temperature-pressure data.

Specifically, according to an embodiment of the present disclosure, the controller 130 may include the reference temperature-pressure data. The reference temperature-pressure data indicates pressure data corresponding to the temperature data, which are measured by the temperature sensor 150 and the pressure sensor 140, when the airtightness of the road wheel actuator 100 is in the normal state.

To be more specific, the controller 130 may receive the temperature data from the temperature sensor 150, and simultaneously receive the pressure data at the temperature data from the pressure sensor 140, thus calculating the pressure data corresponding to the temperature data and storing the calculated pressure data.

Further, the controller 130 may compare the pressure data corresponding to the temperature data, with the pre-inputted reference temperature-pressure data.

In other words, the controller 130 may receive the temperature data and the pressure data from the temperature sensor 150 and the pressure sensor 140, respectively, and may calculate the pressure data corresponding to the temperature data. Further, the controller 130 may compare the pressure data corresponding to the temperature data with the pre-inputted reference temperature-pressure data. Furthermore, when the pressure data corresponding to the temperature data is lower than the reference temperature-pressure data, the controller 130 may determine that there is an abnormality in the airtightness of the road wheel actuator 100.

For example, when the temperature data received from the temperature sensor 150 is 25.0° C., the temperature data of 25.0° C. may be received, and simultaneously the pressure data of 200 mmHg at the temperature data may be received from the pressure sensor 140. Further, the received pressure data of 200 mmHg may be compared with the reference pressure data of 250 mmHg at the previously inputted (stored) temperature data of 25.0° C., and then the difference may be calculated.

When the received pressure data is less than the reference pressure data by a predetermined value, the controller 130 may transmit an electrical signal to the display unit 300, and the display unit 300 may display the airtight state of the housing and the bellows 117 and 119 surrounding the body unit 110, the motor unit 120, and the controller 130.

As such, by comparing the development of changes in the pressure data depending on the temperature data in the housing and the bellows 117 and 119 surrounding the body unit 110, the motor unit 120, and the controller 130 of the road wheel actuator 100, the abnormality of the road wheel actuator 100 (i.e. the airtightness of the road wheel actuator 100) may be detected.

The steering device detecting the abnormality (i.e. the airtightness) of the road wheel actuator 100 according to an embodiment of the present disclosure may include the display unit 300.

The display unit 300 may be electrically connected to the controller 130, and may indicate the airtight state of the road wheel actuator 100.

When it is determined that there is an abnormality in the airtightness of the road wheel actuator 100, the controller 130 may transmit an electrical signal to the display unit 300.

When the display unit 300 receives the electrical signal from the controller 130, the display unit may display the abnormality in the airtightness of the road wheel actuator 100.

The display unit 300 may be a notification light (or warning light), a notification sound (or warning sound), or a notification text (or a notification text) disposed on an instrument panel of the vehicle.

The controller 130 may display the abnormality of the road wheel actuator 100 by turning on the notification light of the display unit 300 or generating the notification sound (S13).

The abnormality of the road wheel actuator 100 displayed on the display unit 300 indicates that the housing and the bellows 117 and 119 surrounding the body unit 110, the cover of the motor unit 120, and the cover 131 of the controller 130 are cracked or damaged, or problems occur in components which may maintain the airtightness, so that the airtight state of the housing and the bellows 117 and 119 surrounding the body unit 110, the motor unit 120, and the controller 130 is not maintained.

As described above, the steering device detecting the airtightness of the road wheel actuator according to an embodiment of the present disclosure may detect whether the abnormality of the road wheel actuator 100 occurs or not, i.e. the airtight state of the road wheel actuator 100 is maintained. Specifically, it is possible to detect whether there is an abnormality in the airtight state of the housing and the bellows 117 and 119 surrounding the body unit 110, the motor unit 120, and the controller 130 of the road wheel actuator 100.

Further, it is possible to detect whether rust forms in the road wheel actuator 110 by checking whether there is an abnormality in the airtight state of the housing and the bellows 117 and 119 surrounding the body unit 110, the motor unit 120, and the controller 130 of the road wheel actuator 100.

Furthermore, it is possible to detect whether there is an abnormality in the road wheel actuator 100 before it is impossible to steer the vehicle due to the abnormality of the road wheel actuator 100, thereby minimizing human and material damage caused by steering inability.

Features, structures, effects, etc. described in the foregoing embodiments are included in at least one embodiment of the present disclosure, and are not necessarily limited to only one embodiment. Furthermore, features, structures, effects, etc. illustrated in each embodiment may be combined or modified by those skilled in the art. Accordingly, contents related to the combination and modification should be interpreted as being included in the scope of the present disclosure.

The above description is merely an exemplary description of the technical scope of the present disclosure, and it will be understood by those skilled in the art that various changes and modifications can be made without departing from original characteristics of the present disclosure. That is, each component specifically shown in the embodiment may be modified and changed. Further, differences related to the modification and application should be construed as being included in the scope of the present disclosure without departing from the appended claims.

### DETAILED DESCRIPTION OF MAIN ELEMENTS

100: road wheel actuator
110: body unit
120: motor unit
130: controller
140: pressure sensor
150: temperature sensor
300: display unit

What is claimed is:

1. A steering device detecting airtightness of a road wheel actuator, the road wheel actuator comprising:
a body unit;
a motor unit connected to the body unit; and
a controller connected to the motor unit,
wherein the controller checks an airtight state of a housing and bellows surrounding the body unit, the motor unit, and the controller.

2. The steering device of claim 1, wherein a pressure sensor is attached to the controller, and
the pressure sensor measures internal pressure of the housing and the bellows surrounding the body unit, the motor unit, and the controller.

3. The steering device of claim 2, wherein the controller comprises reference pressure data,
the controller receives pressure data from the pressure sensor, compares the received pressure data with the reference pressure data, and determines that there is an abnormality in the airtightness of the road wheel actuator when the received pressure data is lower than the reference pressure data, and
the reference pressure data is pressure data measured by the pressure sensor when the airtightness of the road wheel actuator is in a normal state.

4. The steering device of claim 3, further comprising:
a display unit electrically connected to the controller to display an airtight state of the road wheel actuator,
wherein the controller transmits an electrical signal to the display unit when it is determined that there is an abnormality in the airtightness of the road wheel actuator.

5. The steering device of claim 4, wherein the display unit displays the abnormality in the airtightness of the road wheel actuator, when the display unit receives the electrical signal from the controller.

6. The steering device of claim 2, wherein a temperature sensor is attached to the controller, and
the temperature sensor measures internal temperature of the housing and the bellows surrounding the body unit, the motor unit, and the controller.

7. The steering device of claim 6, wherein the controller comprises reference temperature-pressure data,
the controller receives temperature data and pressure data from the temperature sensor and the pressure sensor, respectively, calculates pressure data corresponding to the temperature data, compares the pressure data corresponding to the temperature data with the reference temperature-pressure data, and determines that there is an abnormality in the airtightness of the road wheel actuator when the pressure data corresponding to the temperature data is lower than the reference temperature-pressure data, and
the reference temperature-pressure data is the pressure data corresponding to the temperature data, measured by the temperature sensor and the pressure sensor when the airtightness of the road wheel actuator is in a normal state.

8. The steering device of claim 7, further comprising:
a display unit electrically connected to the controller to display an airtight state of the road wheel actuator,
wherein the controller transmits an electrical signal to the display unit when it is determined that there is an abnormality in the airtightness of the road wheel actuator.

9. The steering device of claim 8, wherein the display unit displays the abnormality in the airtightness of the road wheel actuator, when the display unit receives the electrical signal from the controller.
